(19) United States
(12) Patent Application Publication
(10) Pub. No.: US 2025/0274431 A1
(43) Pub. Date: Aug. 28, 2025

(54) ADDRESS ASSIGNMENT METHOD IN A COMMUNICATION NETWORK

(71) Applicant: WAGO Verwaltungsgesellschaft mbH, Minden (DE)

(72) Inventors: Andreas KRAATZ, Luhden (DE); Daniel JEROLM, Bad Essen (DE)

(73) Assignee: WAGO Verwaltungsgesellschaft mbH, Minden (DE)

(21) Appl. No.: 19/065,535

(22) Filed: Feb. 27, 2025

(30) Foreign Application Priority Data
Feb. 27, 2024 (DE) 10 2024 105 538.3

(51) Int. Cl. H04L 61/5069; H04L 12/50; H04L 61/5076

(52) U.S. Cl. CPC H04L 61/5069; H04L 12/50; H04L 61/5076

(57) ABSTRACT

A method for participant-specific address allocation in a communication network is provided. The communication network may have a plurality of communication participants, in particular at least one address providing communication participant. The communication connections between the communication participants may separable. The method may comprise generating a state of the communication network in which the address providing communication participant can reach exactly one communication participant that does not have a participant-specific address via a broadcast message. This may be based, in particular, on the separable communication connections. The method may comprise sending a broadcast message comprising a participant-specific address to be assigned to the address seeking communication participant in order to enable communication by unicast addressing with the address seeking communication participant. This may be done by the address providing communication participant.

This nonprovisional application claims priority under 35 U.S.C. § 119(a) to German Patent Application No. 10 2024 105 538.3, which was filed in Germany on Feb. 27, 2024, and which is herein incorporated by reference.

### BACKGROUND OF THE INVENTION

### Field of the Invention

The present invention relates generally to the technical field of communications technology, in particular to a method for assigning addresses to communication participants in a communication network. The communication participants may, in particular, be electronic components, for example field devices and/or automation devices and/or building technology devices.

### Description of the Background Art

Today's technological landscape is subject to an ever-increasing degree of interconnection between a wide variety of devices and components. This is particularly the case in highly complex environments, such as infrastructure utilities, factories, buildings, etc. In such environments, a large number of electronic components is used. For example, field devices, automation devices or building technology devices. In order to efficiently manage and maintain these electronic components, it is typically necessary to configure them with respect to their software. Data exchange between the electronic components or with a server is also often desired, for example to exchange measured values and/or status information, and/or to transmit instructions for carrying out certain operations. In this respect, electronic components are communication participants in a communication network.

A prerequisite for communication, as described above, is addressing of the communication participants, i.e., the assignment and/or knowledge of addresses in order to exchange data with the respective communication participants.

The problem can be easily explained based on the example of building technology devices. Building technology devices are technical components inside and outside of buildings that serve the use of said buildings. For example, building technology devices include sun protection systems, lighting systems, fire alarm systems, burglar alarm systems, photovoltaic systems, or access control systems. Such devices should be easy to integrate into a building's communication network and be controllable, for example, by a control unit. Conversely, the devices should report their status and/or other data back to the control unit or carry out a data exchange between the devices. For each of the communication operations mentioned, the communication participants need addresses.

For addressing, there are various solutions in the state of the art. One solution involves the communication participants having a unique ID or serial number provided during manufacturing, from which a unique address can be derived with which a respective communication participant can be addressed. Another solution provides that the communication participants have a unique address provided during manufacturing, which can be called up or read by a master device, which can be formed by a control unit, for example. Further solutions include the use of dip switches or rotary coding switches for manual address assignment. Other solutions provide for manual address assignment in which an external device, for example a mobile device, is connected to the communication participant. Other solutions provide for the allocation of addresses on a random basis, wherein the addresses and especially duplicate addresses can be subsequently detected by a master device and corrected if necessary. Other solutions do not have an internal parallel connection to the communication medium; instead, the data stream is decoded, modified and then forwarded to the next participant. Such an approach allows for reliable address assignment based on the physical position of the participant as a result of the wiring without internal parallel connection, such as EtherCAT or RLB, and is therefore popular.

All of the solutions mentioned have disadvantages. Solutions with dip switches, rotary coding switches or configuration tools require manual access to each participant. This requires additional effort during installation or device replacement and carries the risk of operating error. The physical structure of the communication network cannot be determined, or cannot be determined completely, by the master. Solutions without internal parallel connection such as EtherCAT or RLB require a more complex bus interface with an ASIC or FPGA and introduce additional latency when forwarding the data. The energy consumption is also relatively high. Solutions without internal parallel connection and without bus connection in an ASIC or FPGA can also receive the data stream through a microcontroller and forward it to the next participant with the help of software. These solutions have high latency in forwarding data and also have higher energy consumption. Solutions with a unique ID or serial number available ex works have the following disadvantages: A pool of IDs must be available and managed; the infrastructure for generating a unique ID must be available in production; for devices that are created as prototypes in sample construction or development, the ID must be assigned manually; the physical structure of the communication network cannot be determined or cannot be determined completely by the master. Solutions with an additional line in addition to the communication lines require additional pins on the connectors and additional wires in connecting cables. This can increase costs. Solutions with randomly chosen addresses require reliable detection of duplicate addresses and a way to correct the assigned addresses. This usually requires collision detection on the transmission medium, which increases the required effort and complexity of the hardware and software. In addition, the physical structure of the communication network cannot be determined, or cannot be completely determined, by the master.

There is therefore a need to provide an improved address allocation procedure compared to the state of the art.

### SUMMARY OF THE INVENTION

It is therefore an object of the present invention is to provide a method which overcomes the disadvantages of existing solutions.

According to a first aspect of the present invention, a method for participant-specific address allocation in a communication network is provided. The communication network may have a plurality of communication participants, in particular at least one address providing communication participant. The communication connections between the communication participants may be separable. The method may comprise generating a state of the communication network in which the address providing communication participant can reach exactly one communication participant that does not have a participant-specific address via a broadcast message. This may be based, in particular, on the separable communication connections. The method may comprise sending a broadcast message comprising a participant-specific address to be assigned to the address seeking communication participant in order to enable communication by means of unicast addressing with the address seeking communication participant. This may be done by the address providing communication participant.

A communication network may be viewed as an arrangement of units that are capable of communicating with each other unidirectionally or bidirectionally. It enables the exchange of information between these units, which may be called communication participants. For example, a local area network (LAN) in an office or a wired building network with a master-slave architecture may be considered a communication network.

A communication participant in the sense of the present invention refers to any component that is capable of electronically transmitting and/or receiving data, i.e. communicating. Communication participants may, in particular, be electronic components. An electronic component may, in particular, be a field device and/or an automation device and/or a building technology device.

For the purposes of the present invention, a field devices can be, for example, any type of device that can be used in industrial applications to perform measurements and/or operations. Examples of this may be electrical switches, bus systems, electrical measuring devices, and/or the like.

The term “automation device” can refer to devices that may automatically control, regulate, and/or monitor processes without, or substantially without, human intervention. They may be part of industrial control and regulation systems and may include, for example, PLCs, robot systems, or production control systems.

For the purposes of the present invention, the term “building technology device” can mean all permanently installed and mobile technical systems inside and outside a building that serve the use of said buildings. Examples of building technology devices include sun protection systems, air conditioning systems, heating systems, lighting systems, fire alarm systems, burglar alarm systems, photovoltaic systems, or access control systems.

Address assignment is the process by which unique identifiers (addresses) are assigned to the communication participants within a communication network. These addresses enable communication participants to be uniquely identified and thus establish specific communication connections. Examples include the assignment of MAC addresses, IP addresses, or proprietary addresses in a communication network.

A participant-specific address is a unique address that is specifically assigned to a particular communication participant within the communication network. For example, a special MAC address may be assigned to a specific communication participant in the communication network.

An address providing communication participant is a communication participant that can assign participant-specific addresses within the communication network. This may, for example, be a server that assigns IP addresses in a network or a control device that assigns MAC addresses.

A communication connection is the combination of the physical and logical connection that enables communication between communication participants in a communication network. An example of this could be a wired communication line between communication participants.

A separable communication connection is a type of communication connection that can be opened or closed as needed. This may be achieved through physical components, such as switches, or through software-controlled methods, such as disabling a specific interface.

In the context of the present invention, an address seeking communication participant is a communication participant that does not have a participant-specific address and may receive a message from the address providing communication participant. For example, if the communication connections between the communication participants are to be separable, the communication connections can be separated and only one communication connection can be established, which exists between the address providing communication participant and a communication participant without a participant-specific address, which in this respect is the address seeking communication participant. In complex, for example non-star-shaped communication networks, the broadcast message of the address providing communication participant may be received by a large number of communication participants that are intermediate the address providing communication participant and the precisely one address seeking communication participant, wherein the broadcast message is ignored by the intermediate communication participants because they already have a participant-specific address.

A broadcast message is a message that is sent to all communication participants or a group of communication participants in a network. For example, such a message could be sent by a server or by a control unit.

Unicast addressing is a type of message transmission in a communication network in which a message is addressed directly from the sender to a specific recipient. In particular, the message may comprise the address of the recipient, i.e., of the receiving communication participant.

The present invention is advantageous in terms of efficiency and flexibility in address allocation within communication networks. The method according to the invention significantly optimizes address allocation in a communication network. The heart of the invention is the generation of a special state of the communication network in which exactly one address seeking communication participant can be reached by a broadcast message. This simplifies and accelerates the process of address assignment because the address providing communication participant can operate with broadcast messages and yet only a selected, address seeking unit is addressed. This minimizes the risk of address conflicts or duplications, which could disrupt communication in a network. Once the address has been assigned, the procedure enables the use of unicast addressing. This enables direct and efficient communication in the communication network, especially with very low latency.

After the addresses have been assigned, configurations or queries of measurement and/or state data may be carried out, wherein individual communication participants can be addressed specifically using unicast addressing. The term configuration may in particular include the setting of an electronic component, which can be a communication participant. The aim of a configuration may be for the electronic component to perform functions and/or to achieve certain behaviors and/or to have certain properties. Configuration processes may, in particular, be the programming and/or setting of parameters.

The communication network may be configured to have a master-slave architecture. The at least one address providing communication participant may be a master participant, wherein preferably the exactly one address seeking communication participant can be a slave participant. The communication network may comprise at least two slave participants.

A master-slave architecture has the advantage of providing a clear hierarchy and a clear control structure. The master participant, in this case the address provider, assigns the addresses and controls the process. This makes it easier to manage and monitor the entire process as there is a central control authority. There may be several master participants, wherein, for example, each master participant is responsible for, or is assigned to, a subset, preferably a proper subset, of the slave participants of the communication network.

It is possible that a reliable infrastructure for communication between a master participant and several slave participants already exists and it is desired to add additional slave participants. This is possible in a simple manner according to the present invention, since by establishing the state in which exactly one slave can be reached without a subscriber-specific address, addresses can be assigned subsequently particularly easily. An expansion of the communication network is therefore possible in a simple way.

The method may further comprise receiving, by the address seeking communication participant, the broadcast message. Furthermore, the method may comprise adopting, by the address seeking communication participant, the participant-specific address contained in the received broadcast message in order to enable communication with the address seeking communication participant through unicast addressing. The broadcast message preferably comprises a command to the following effect: Adopt the address contained in the broadcast message as the subscriber-specific address if no participant-specific address exists yet.

The separability of the communication connections between the communication participants may be realized by means of electronic switches, which may be opened and closed, in particular via messages from the address providing communication participant, in order to separate or establish respective communication connections. In particular, each communication connection may be separable, wherein preferably each communication participant has at least one electronic switch.

Thus, the concept of separability of communication relationships may be realized in a simple manner by implementing electronic switches. The use of electronic switches contributes to the efficiency and speed of the address assignment, as they can react immediately to the signals or messages from the address provider.

Method steps of the present invention may be carried out iteratively until each communication participant has a participant-specific address in order to enable communication by means of unicast addressing.

The step of generating the state of the communication network may comprise sending, by the address providing communication participant, at least one preparatory broadcast message for effecting at least one operation in communication participants receiving the at least one preparatory broadcast message. Preferably, the execution of an operation by communication participants is linked to a condition, wherein the condition may comprise that the respective communication participant does not have a participant-specific address.

Preparatory messages enable network actors to perform specific actions that assist in bringing the network into the optimal state for address assignment. This improves the preparation of the network for address assignment and supports an efficient and orderly implementation of the address allocation process.

Furthermore, the at least one preparatory broadcast message may comprise at least one of the following commands: establish all possible communication connections, in particular by closing electrical switches; and/or if no participant-specific address is available, disconnect all possible communication connections, in particular by opening electrical switches; and/or if a participant-specific address is available, remove the participant-specific address; and/or adopt the address contained in the broadcast message as the participant-specific address if no participant-specific address is available yet.

The diverse possibilities of the preparatory broadcast messages are optimally utilized and expanded with these command options. The first option, “establish all possible communication connections, in particular by closing electrical switches,” allows the network to be brought into a state in which all participants are connected to each other. This can be useful in situations where broad communication or command dissemination to all participants is required. In particular, this may ensure that the communication network does not have any disconnected branches that cannot be reached during the further course of the process and hence cause errors. The message may be sent several times in succession to reduce the probability of packet loss or other errors occurring.

The second option, “disconnect all possible communication connections, in particular by opening electrical switches, if no participant-specific address is available yet”, enables targeted and efficient address allocation by isolating address seeking participants from the others.

The third option, “if a participant-specific address is available, remove the participant-specific address”, provides an additional layer of control in the address assignment. This allows the system to remove the originally assigned address and assign a new, more appropriate address if necessary.

The fourth option, “adopt the address contained in the broadcast message as participant-specific address if no participant-specific address is available yet”, offers an optimal solution for the address assignment itself. This means that if a participant does not yet have an address, it can adopt the address specified in the message and consequently become an addressed participant.

Overall, the use of a preparatory message, as described above, offers a high degree of flexibility and precision in carrying out the method according to the present invention.

The method may further comprise sending, in particular by the address providing communication participant, at least one unicast message. The at least one unicast message may comprise at least one of the following commands: establish a specific communication connection, in particular by closing at least one electrical switch; and/or share existing properties, in particular the number of existing communication connections to other communication participants.

This extends the functions and possibilities of the address allocation method by including unicast messages. This is advantageous in terms of targeted communication and fine-tuning of network actions, in particular for establishing the desired state mentioned above in which only one address seeking communication participant can be reached. Specific communication connections can be easily established or disconnected, in particular by closing electrical switches.

The command “share existing properties, in particular with regard to the number of existing communication connections to other communication participants” enables the acquisition of further relevant network data, which makes it possible to iteratively recreate the above-mentioned state until all communication participants have a participant-specific address.

The step of generating the state of the communication network may comprise: sending, preferably sending multiple times, by the address providing communication participant, a preparatory broadcast message to effect the following operation in communication participants which receive the preparatory broadcast message: establish all possible communication connections, preferably by closing electrical switches; sending, by the address providing communication participant, a preparatory broadcast message to effect the following operation at communication participants that receive the preparatory broadcast message: remove the participant-specific address if a participant-specific address is available; disconnecting all communication connections at the address providing communication participant, preferably by opening electrical switches; establishing exactly one communication connection at the address providing communication participant, preferably by closing an electrical switch, or establishing exactly one communication connection at a communication participant that is not the address providing communication participant by sending a preparatory unicast message to effect the following operation at that communication participant that receives the preparatory unicast message: establish exactly one communication connection, preferably by closing electrical switches; and/or sending, by the address providing communication participant, a preparatory broadcast message to effect the following operation in communication participants that receive the preparatory broadcast message: disconnecting, if no participant-specific address is yet available, all possible communication connections, preferably by opening electrical switches.

Different communication lines may be used for sending and receiving messages by communication participants.

Using different communication lines for sending and receiving messages by communication participants may assist in avoiding interference between sending and receiving, because these processes are carried across different paths. This can improve the overall communication quality and efficiency in the network and reduce potential bottlenecks and congestion.

At least one communication participant may have a switch functionality which provides at least one interface for arranging at least one communication line for arranging a plurality of communication participants, in particular communication participants connected in parallel.

A communication participant with switch functionality may provide several interfaces for different communication lines and increase flexibility with regard to the connection layout in the network.

The slave participants may be arranged in parallel on a communication line of the communication network and/or the slave participants may be organized in two or more groups on a communication participant with switch functionality, in particular on a slave participant with switch functionality, wherein the slave participants of each group are connected in parallel to one interface of the communication participant with switch functionality.

Organizing the slave participants into groups, especially by means of communication participants with switch functionality, enables structured and efficient communication between the participants. By using common interfaces, the number of required connections may be reduced while still allowing effective communication between all network participants.

According to a second aspect of the present invention, an address providing communication participant is provided, preferably a master participant of a communication network with a master-slave architecture. The address providing communication participant may be configured to carry out respective steps according to the first aspect of the present invention.

According to a third aspect of the present invention, a communication participant, preferably a slave participant of a communication network with a master-slave architecture, may be provided which is configured to adopt a participant-specific address by a method according to the first aspect of the present invention.

According to a fourth aspect of the present invention, a communication network is provided, comprising at least one address providing communication participant according to the second aspect of the present invention and at least one communication participant according to the third aspect of the present invention, wherein the communication network is configured to carry out a method according to the first aspect of the present invention.

In the communication network, preferably all communication participants may be configured according to the third aspect of the present invention to support the following commands, which may be received through broadcast messages: establish all possible communication connections, in particular by closing electrical switches; and/or if no participant-specific address is available, disconnect all possible communication connections, in particular by opening electrical switches; and/or if a participant-specific address is available, remove the participant-specific address; and/or use the address contained in the broadcast message as the participant-specific address if no participant-specific address is available yet.

In the communication network, preferably all communication participants may be configured according to the third aspect of the present invention to support the following commands, which may be received by means of unicast addressing: establish a specific communication connection, in particular by closing at least one electrical switch; and/or share existing properties, in particular the number of existing communication connections to other communication participants.

According to a fifth aspect of the present invention, a computer program or a computer-readable medium is provided, comprising instructions which cause a computer, in particular a device according to the second and/or fourth aspect of the present invention, to carry out a method according to the first aspect of the present invention.

All features, technical details and advantages described with respect to one of the aspects of the present invention also apply mutatis mutandis to each of the other aspects of the present invention and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a first schematic depiction of an example of the present invention.

FIG. 2 shows a schematic detailed view of a communication participant according to an example of the present invention.

FIG. 3: Shows a second schematic depiction of an example of the present invention.

FIG. 4 shows a third schematic depiction of an example of the present invention.

FIG. 5 shows a first exemplary state of a communication network according to an example of the present invention.

FIG. 6 shows a second exemplary state of a communication network according to an example of the present invention.

FIG. 7: Shows an exemplary flowchart of an example of the present invention.

FIG. 8a shows a first portion of an exemplary flowchart of an example of the present invention.

FIG. 8b shows a second portion of an exemplary flowchart of an example of the present invention.

### DETAILED DESCRIPTION

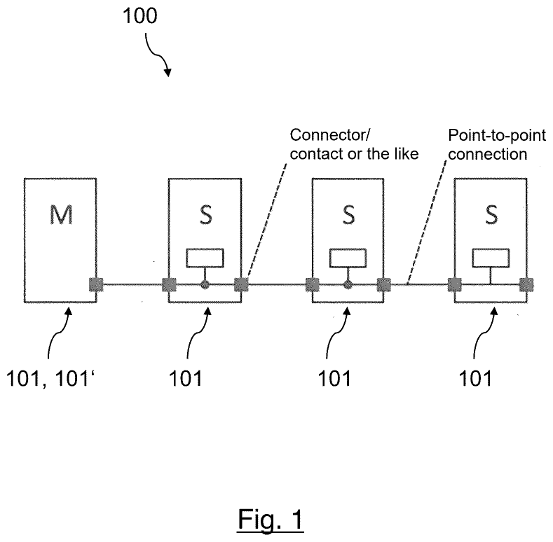

FIG. 1 shows an example of a simple communication network 100 according to embodiments of the present invention. The communication network 100 comprises several communication participants 101, wherein one communication participant 101 is an address providing communication participant 101′. The communication network 100 has a master-slave architecture, which is indicated by the letters M and S in the figure. The address providing communication participant 101′ is a master participant M. The other communication participants 101 are slave participants S. The communication participants 101 are connected by communication connections. The communication connections may, in particular, be wired communication connections which are based, for example, on connectors and/or contacts and/or I/O interfaces. From a physical perspective, these may be point-to-point communication connections between the communication participants 101. In FIG. 1, there is a continuous communication line to which the communication participants 101 are connected in parallel, thus forming an internal parallel connection of slave participants S.

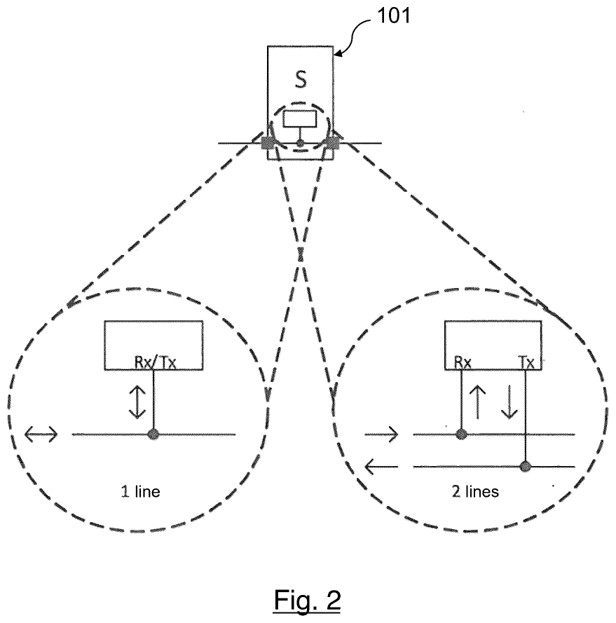

FIG. 2 shows an example of a possible structure of a communication participant 101, specifically a slave participant S, and the communication connection. The communication connection may be based on one line, via which the slave participant S may send and receive (Rx and Tx on one line), or based on two lines, wherein sending and receiving may take place on different lines (Rx line and Tx line).

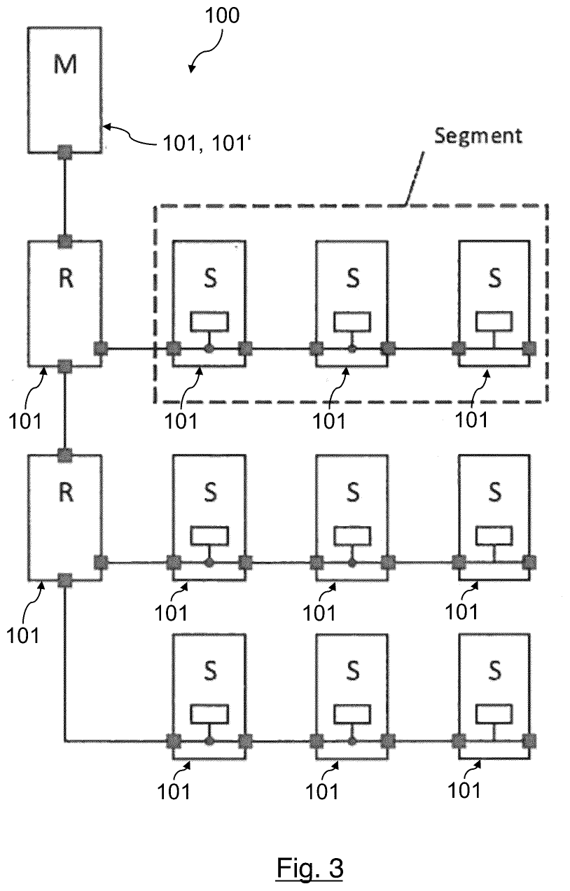

FIG. 3 shows another exemplary embodiment of a communication network 100 according to embodiments of the present invention. The communication network 100 has a tree structure which is formed by an address-transmitting communication participant 101′ which is configured to be a master participant M and by eleven communication participants 101 which are configured to be slave participants S, wherein two of the communication participants 101 which are configured to be slave participants S comprise a switch functionality, as indicated by the letter R in FIG. 3. The communication participants 101, which are configured to be slave participants S and comprise a switch functionality, form, due to their switch functionality, the nodes for the tree structure, at which respective segments of the communication network 100 are arranged. In other words, groups of communication participants 101 which are configured to be slave participants S may be connected in parallel in separate segments.

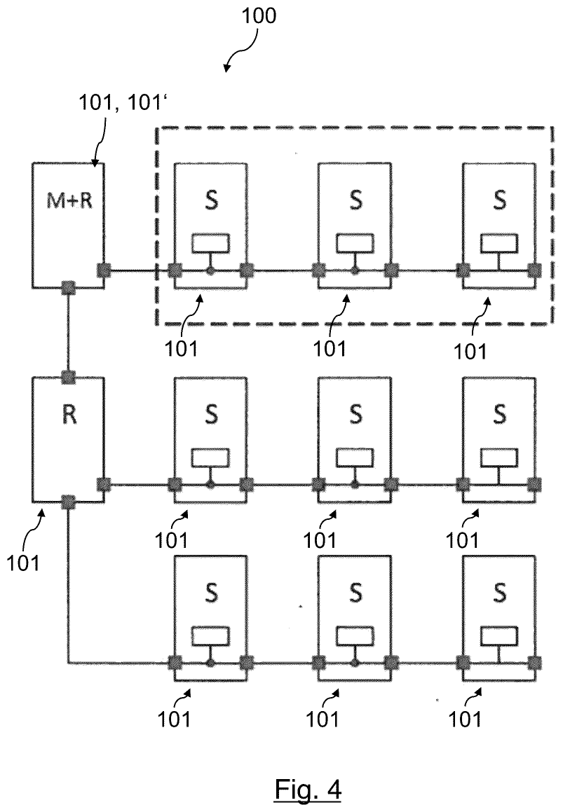

FIG. 4 shows another exemplary embodiment of a communication network 100 according to embodiments of the present invention. FIG. 4 differs from FIG. 3 in that the address providing communication participant 101′, which is configured to be the master participant M, has a switch functionality and thus the communication network is even simpler in structure as it, to put it differently, comprises one fewer communication participant.

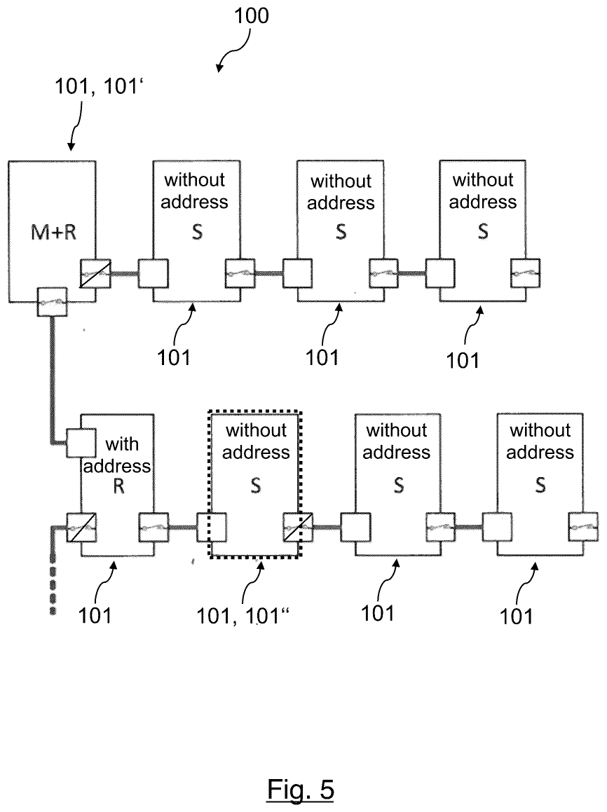

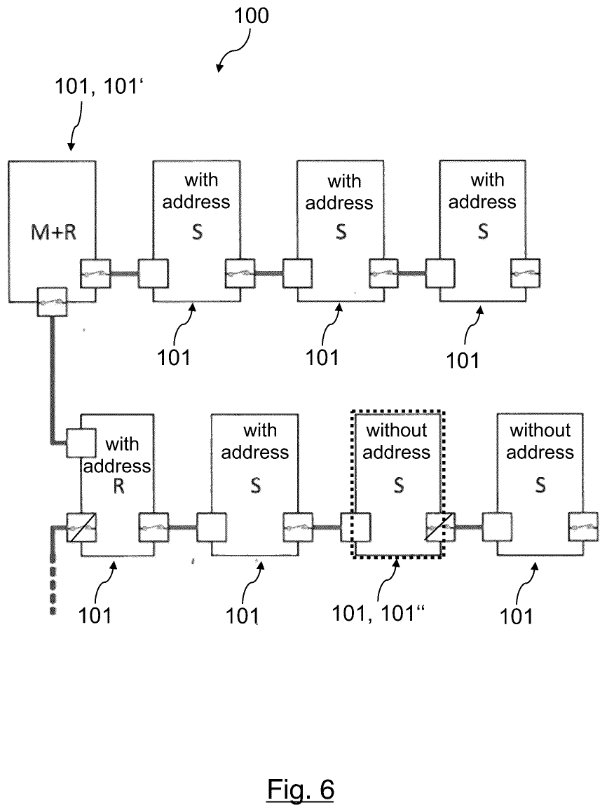

FIGS. 5 and 6 each show exemplary states of a communication network according to embodiments of the present invention, in which exactly one address seeking communication participant 101″ without a participant-specific address can be reached by means of a broadcast message. This state is realized by means of electronic switches that can be opened or closed.

In the example of FIG. 5, all communication participants 101 which are configured to be slave participants S have no participant-specific address. The aim is to provide a specific address seeking communication participant 101″, which is surrounded by dashed lines, with a participant-specific address. For this purpose, a state was created, as shown in FIG. 5, in which, based on the separable communication connections, the address providing communication participant 101′ can reach exactly the desired address-seeking communication participant 101″ via a broadcast message as the only communication participant 101 who does not have a participant-specific address, and can instruct the address-seeking communication participant 101″ to adopt the participant-specific address. Disconnected communication connections and the respective opened electronic switches are shown crossed out.

In the example of FIG. 6, some communication participants 101 already have a participant-specific communication address. Here, too, a state is shown in which exactly one desired address seeking communication participant 101″ can be provided with a participant-specific address by means of a broadcast message. This one is again surrounded by a dashed line.

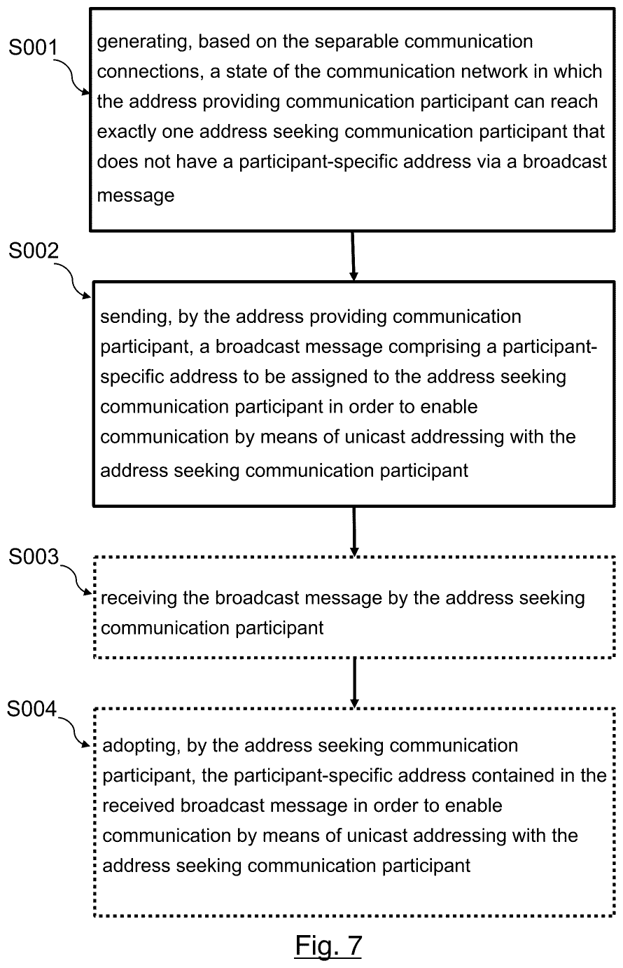

FIG. 7 shows a flowchart with steps according to embodiments of the present invention. Step S001 comprises generating, based on the separable communication connections, a state of the communication network 100 in which the address providing communication participant 101′ can reach exactly one address seeking communication participant 101″ that does not have a participant-specific address via a broadcast message. Step S002 comprises sending, by the address providing communication participant 101′, a broadcast message comprising a participant-specific address to be assigned to the address seeking communication participant 101″ in order to enable communication by means of unicast addressing with the address seeking communication participant 101″.

The optional step S003, indicated by the dashed frame, comprises receiving the broadcast message by the address seeking communication participant 101″. The optional step S004, indicated by the dashed frame, comprises adopting, by the address seeking communication participant 101″, the participant-specific address contained in the received broadcast message in order to enable communication by means of unicast addressing with the address seeking communication participant 101″, wherein the broadcast message may comprise a command to the following effect: adopt the address contained in the broadcast message as a participant-specific address if no participant-specific address is yet available.

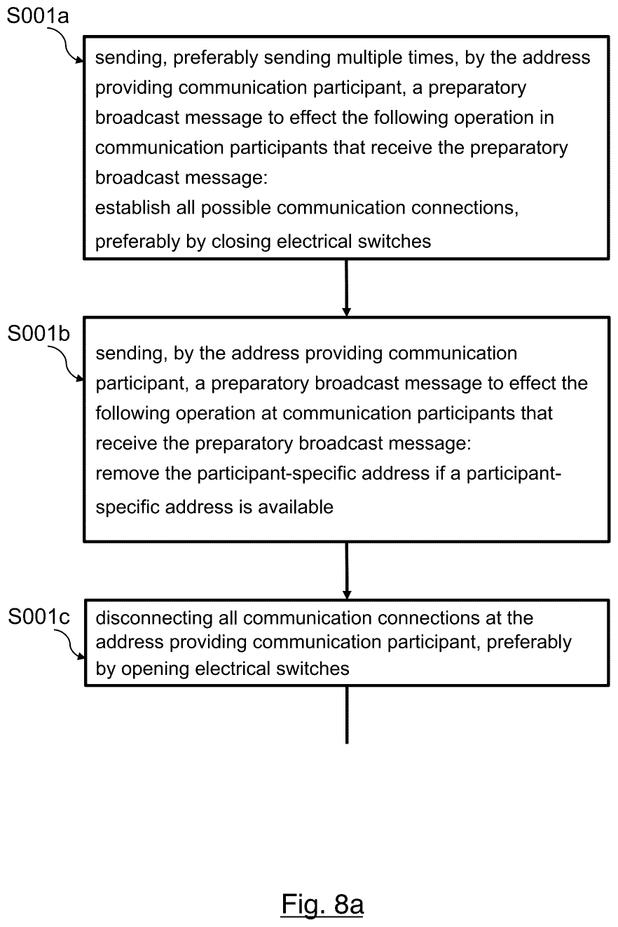

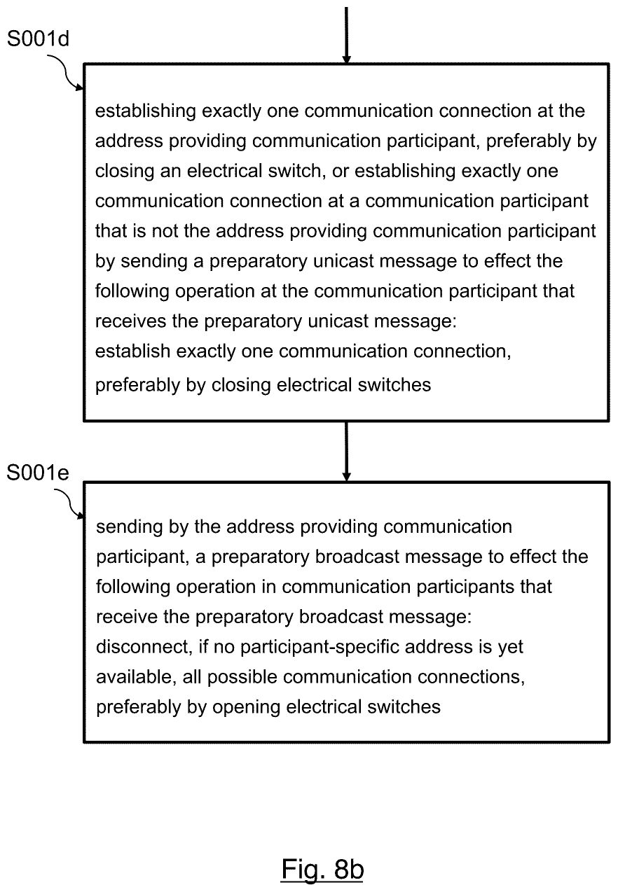

FIGS. 8a and 8b show a two-part exemplary flow chart for carrying out step S001. The flow chart comprises, in step S001a, sending, preferably sending multiple times, by the address providing communication participant 101′, a preparatory broadcast message to effect the following operation in communication participants 101 that receive the preparatory broadcast message: establish all possible communication connections, preferably by closing electrical switches. The flow chart further comprises, in step S001b, sending, by the address providing communication participant 101′, a preparatory broadcast message to effect the following operation at communication participants 101 that receive the preparatory broadcast message: remove the participant-specific address if a participant-specific address is available. The flow chart further comprises, in step S001c, disconnecting all communication connections at the address providing communication participant, preferably by opening electrical switches. The flow chart further comprises, in step S001d, establishing exactly one communication connection at the address providing communication participant 101′, preferably by closing an electrical switch, or establishing exactly one communication connection at a communication participant 101 that is not the address providing communication participant 101′ by sending a preparatory unicast message to effect the following operation at the communication participant 101 that receives the preparatory unicast message: establish exactly one communication connection, preferably by closing electrical switches; The flow chart further comprises, in step S001e, sending by the address providing communication participant, a preparatory broadcast message to effect the following operation in communication participants 101 that receive the preparatory broadcast message: disconnect, if no participant-specific address is yet available, all possible communication connections, preferably by opening electrical switches.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for participant-specific address allocation in a communication network, wherein the communication network has at least two communication participants comprising at least one address providing communication participant, wherein communication connections between the communication participants are separable, the method comprising:
generating, based on the separable communication connections, a state of the communication network in which the address providing communication participant reaches exactly one address seeking communication participant that does not have a participant-specific address via a broadcast message; and
sending, by the address providing communication participant, a broadcast message comprising a participant-specific address to be assigned to the address seeking communication participant in order to enable communication via unicast addressing with the address seeking communication participant.

2. The method of claim 1, wherein the communication network has a master-slave architecture, wherein the at least one address providing communication participant is a master participant, wherein the exactly one address seeking communication participant may be a slave participant, and wherein the communication network comprises at least two slave participants(S).

3. The method according to claim 1, the method further comprising:
receiving the broadcast message by the address seeking communication participant; and
adopting, by the address seeking communication participant, the participant-specific address contained in the received broadcast message in order to enable communication via unicast addressing with the address seeking communication participant, wherein the broadcast message may comprise a command to the following effect: adopt the address contained in the broadcast message as a participant-specific address if no participant-specific address is yet available.

4. The method according to claim 1, wherein the separability of the communication connections between the communication participants is realized by electronic switches, which are adapted to be opened and closed by messages from the address providing communication participant in order to separate or establish respective communication connections, wherein each communication connection is designed to be separable, and wherein each communication participant has at least one electronic switch.

5. The method according to claim 1, wherein the method steps are carried out iteratively until each communication participant has a participant-specific address in order to enable communication by unicast addressing.

6. The method according to claim 1, wherein the step of generating the state of the communication network comprises:
sending, by the address providing communication participant, at least one preparatory broadcast message for effecting at least one operation in communication participants receiving the at least one preparatory broadcast message,
wherein the execution of an operation by communication participants is linked to a condition, and
wherein the condition comprises that the respective communication participant does not have a participant-specific address.

7. The method of claim 6, wherein the at least one preparatory broadcast message comprises at least one of the following commands:
establish all possible communication connections, in particular by closing electrical switches; and/or
if no participant-specific address is available, disconnect all possible communication connections, in particular by opening electrical switches; and/or
if a participant-specific address is available, remove the participant-specific address; and/or adopt the address contained in the broadcast message as the participant-specific address if no participant-specific address is available yet.

8. The method according to claim 1, the method further comprising:
sending, by the address providing communication participant, at least one unicast message,
wherein the at least one unicast message comprises at least one of the following commands:
establish a specific communication connection by closing at least one electrical switch; and/or
share existing properties or the number of existing communication connections to other communication participants.

9. The method according to claim 1, wherein the step of generating the state of the communication network comprises:
sending or sending multiple times, by the address providing communication participant, a preparatory broadcast message to effect the following operation in communication participants receiving the preparatory broadcast message: establish all possible communication connections by closing electrical switches;
sending, by the address providing communication participant, a preparatory broadcast message to effect the following operation at communication participants that receive the preparatory broadcast message: remove the participant-specific address if a participant-specific address is available;
disconnecting all communication connections at the address providing communication participant by opening electrical switches;
establishing exactly one communication connection at the address providing communication participant by closing an electrical switch, or establishing exactly one communication connection at a communication participant that is not the address providing communication participant by sending a preparatory unicast message to effect the following operation at the communication participant that receives the preparatory unicast message: establish exactly one communication connection, preferably by closing electrical switches; and
sending, by the address providing communication participant, a preparatory broadcast message to effect the following operation in communication participants that receive the preparatory broadcast message: disconnect, if no participant-specific address is yet available, all possible communication connections, preferably by opening electrical switches.

10. The method according to claim 1, wherein different communication lines are used for sending and receiving messages by communication participants.

11. The method according to claim 1, wherein at least one communication participant has a switch functionality which provides at least one interface for arranging at least one communication line for arranging a plurality of communication participants or communication participants connected in parallel.

12. The method according to claim 2, wherein the slave participants are arranged in parallel on a communication line of the communication network and/or the slave participants are organized in two or more groups on a communication participant with switch functionality or on a slave participant with switch functionality, and wherein the slave participants of each group are connected in parallel to one interface of the communication participant with switch functionality.

13. An address providing communication participant or a master participant of a communication network comprising a master-slave architecture, which is configured to carry out the method according to claim 1.

14. A communication participant or a slave participant of a communication network with a master-slave architecture, which is configured to adopt a participant-specific address by the method according to claim 1.

15. A communication network comprising at least one address providing communication participant according and at least one communication participant, wherein the communication network is configured to carry out the method according to claim 1.

16. The communication network of claim 15, wherein communication participants are configured to support the following commands that are receivable via broadcast messages:
establish all possible communication connections by closing electrical switches; and/or
if no participant-specific address is available, disconnect all possible communication connections, in particular by opening electrical switches; and/or if a participant-specific address is available, remove the participant-specific address; and/or
use the address contained in the broadcast message as the participant-specific address if no participant-specific address is available yet.

17. The communication network of claim 15, wherein communication participants are configured to support the following commands that are receivable via broadcast messages:
establish a specific communication connection by closing at least one electrical switch; and/or
share existing properties or the number of existing communication connections to other communication participants.

18. A computer program or a computer-readable medium comprising instructions which cause a computer to carry out the method according to claim 1.
